(19) United States
(12) Patent Application Publication
(10) Pub. No.: US 2026/0328122 A1
(43) Pub. Date: Oct. 22, 2026

(54) OIL-FILTER HOUSING ASSEMBLY HAVING AT LEAST ONE MAGNETIC ELEMENT

(71) Applicant: Figurati Designs, LLC, Akron, OH (US)

(72) Inventor: Kerry Cromer, Akron, OH (US)

(73) Assignee: Figurati Designs, LLC, Akron, OH (US)

(21) Appl. No.: 19/548,294

(22) Filed: Feb. 24, 2026

Related U.S. Application Data
(60) Provisional application No. 63/770,115, filed on Mar. 11, 2025.

(51) Int. Cl. F01M 11/03; B01D 35/00; B01D 35/06; B01D 35/147; B03C 1/28

(52) U.S. Cl. CPC F01M 11/03; B01D 35/005; B01D 35/06; B01D 35/147; B03C 1/286; B01D 2201/4092; B03C 2201/18; B03C 2201/30

(57) ABSTRACT

Provided is an oil filter for filtering ferromagnetic material from engine oil. A housing has an interior space that is to at least partially receive a filter element. An entry cap forms at least a portion of an inlet port, and at least a portion of an outlet port. The filter element also includes a bypass cap and a perforated-filter medium having a linear length that is less than a linear distance from the entry cap to the bypass cap. The perforated-filter medium forms a periphery of a filtered-oil chamber. At least a portion of a magnet is positioned within the filtered-oil chamber and configured to magnetically attract ferromagnetic material. A bypass-valve assembly is coupled to the bypass cap, and causes a portion of engine oil within the housing to bypass the perforated-filter medium in response to an oil pressure within the housing exceeding a threshold pressure.

### CROSS-REFERENCE TO RELATED APPLICATIONS

This patent application claims the benefit of U.S. provisional patent application Ser. No. 63/770,115 filed on Mar. 11, 2025. The subject matter of U.S. provisional patent application Ser. No. 63/770,115 is incorporated by reference into this application.

### BACKGROUND OF THE INVENTION

### 1. Field of the Invention

This application relates generally to a method and apparatus for at least partially removing ferromagnetic materials from engine-oil fluid circulating in an engine and, more specifically, to an oil filter including a filter element and a magnet within an interior space of the filter element.

### 2. Description of Related Art

Engine-oil filters are known, and there remains a need for an improvement on filtering ferromagnetic material from circulating engine oil.

### BRIEF SUMMARY OF THE INVENTION

The effectiveness of conventional oil filters with a magnet arranged externally of a housing is limited. The external magnet may magnetically attract and remove relatively-large ferromagnetic materials having a characteristic dimension that is greater than a mesh size of the filter element disposed within the housing. As a result, an external magnet may become fouled by ferromagnetic materials that would have been filtered from circulating engine oil by the filter element, allowing relatively-small ferromagnetic materials that can pass through filter element to remain entrained in the engine oil.

According to one aspect, the subject application involves an oil filter for filtering ferromagnetic material from engine oil. The oil filter includes a housing having an interior space, and a filter element at least partially received within the interior space. The filter element includes an entry cap that forms (i) at least a portion of an inlet port configured to allow engine oil to enter the housing, and (ii) at least a portion of an outlet port configured to allow engine oil to exit the housing. The filter element also includes a bypass cap and a perforated-filter medium having a linear length that is less than a linear distance from the entry cap to the bypass cap. The perforated-filter medium forms a periphery of a filtered-oil chamber. At least a portion of a magnet is positioned within the filtered-oil chamber and configured to magnetically attract ferromagnetic material, and a bypass-valve assembly is coupled to the bypass cap. The bypass-valve assembly is operable in response to an oil pressure within the housing exceeding a threshold pressure to cause a portion of oil within the housing to bypass the perforated-filter medium.

According to another aspect, the subject application involves an oil filter for filtering ferromagnetic material from engine oil. The oil filter includes a housing having an interior space, and a filter element received at least partially within the interior space. The filter element includes an entry cap that forms (i) at least a portion of an inlet port configured to allow engine oil to enter the housing, and (ii) at least a portion of an outlet port configured to allow engine oil to exit the housing. The filter element also includes a bypass cap having a bypass-cap aperture and a removable insert that is installable within the bypass-cap aperture. A perforated-filter medium having a linear length that is less than a linear distance from the entry cap to the bypass cap forms a periphery of a filtered-oil chamber. At least a portion of a magnet is positioned within the filtered-oil chamber and configured to magnetically attract ferromagnetic material. A bypass-valve assembly is configured to cause a portion of oil within the housing to bypass the perforated filter medium in response to an oil pressure within the housing exceeding a threshold pressure. Upon removing the removable insert, the magnet may be removed from the filter element via the bypass-cap aperture.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 is a side view of an illustrative vehicle including an internal combustion engine equipped with an embodiment of an oil filter in accordance with the present disclosure;

FIG. 2 is an enlarged view of a portion of the internal combustion engine including the embodiment of the oil filter enclosed by a circle in FIG. 1;

FIG. 3 is a perspective view of a distal end of an embodiment of an oil filter in accordance with the present disclosure;

FIG. 4 is a perspective view of a proximate end of an embodiment of an oil filter in accordance with the present disclosure;

FIG. 5 is a perspective, partially-exploded view of a filter element partially removed from a housing of an embodiment of an oil filter in accordance with the present disclosure;

FIG. 6 is a side view of an embodiment of a filter element of an oil filter in accordance with the present disclosure;

FIG. 7 is a perspective view of an embodiment of an entry cap provided to a filter element of an oil filter in accordance with the present disclosure;

FIG. 8 is a perspective view of an embodiment of a bypass cap provided to a filter element of an oil filter in accordance with the present disclosure;

FIG. 9 is an exploded view of an embodiment of a filter element in accordance with the present disclosure;

FIG. 10 is a cross-sectional view of an embodiment of a filter element taken along line 10-10 in FIG. 6, in accordance with the present disclosure; and

FIG. 11 is an exploded view of an embodiment of a filter element in accordance with the present disclosure.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

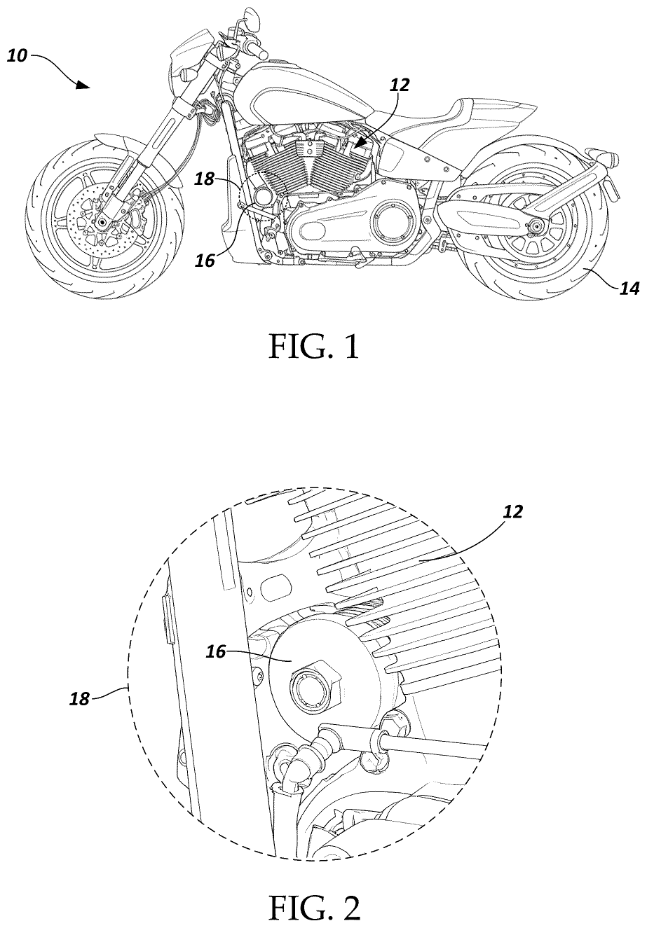

An example of a vehicle in the form of a motorcycle 10 including an internal combustion engine 12 is shown in FIG. 1. Internal combustion engine 12 compresses and ignites a mixture of fuel and oxygen through operation of various moving internal components to drive a rear wheel 14 of motorcycle 10, thereby propelling motorcycle 10 forward. Engine oil is circulated within internal combustion engine 12 to lubricate the moving components and to mitigate damage resulting from friction. Debris, such as shavings of ferromagnetic material removed from surfaces of internal combustion engine 12, can become entrained in the engine oil and create the potential for abrasive wear. Internal combustion engine 12 is equipped with an oil filter 16 configured to filter at least a portion of the debris, including ferromagnetic material, from the circulating engine oil to reduce the potential for abrasive wear to occur.

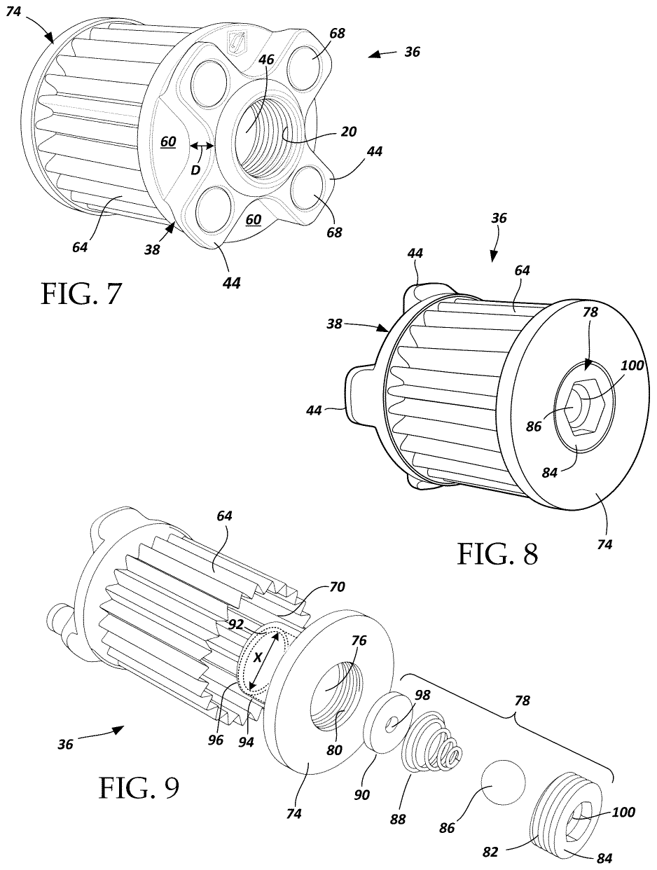

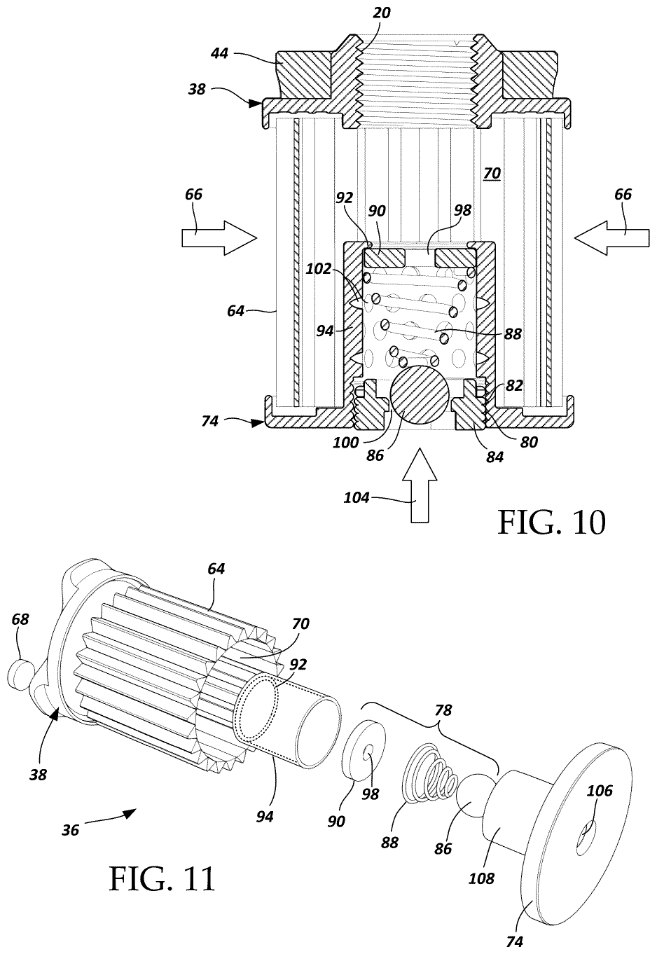

A portion of internal combustion engine 12 within circle 18 is enlarged for clarity in FIG. 2. To releasably couple oil filter 16 to internal combustion engine 12, internal threading 20 described below with reference to FIG. 4, FIG. 7 and FIG. 10 engages external threading provided to a conduit in fluid communication with an oil sump of internal combustion engine 12. Engine oil pumped through internal combustion engine 12 flows into oil filter 16, where it is filtered before flowing through the conduit and back into internal combustion engine 12. Although oil filter 16 is described herein as being installed adjacent a forward portion of internal combustion engine 12 of motorcycle 10 for clarity and brevity, the present disclosure is not so limited. Oil filter 16 can be installed on internal combustion engine 12 provided to any vehicle or other motorized apparatus to filter particulate debris from circulating oil.

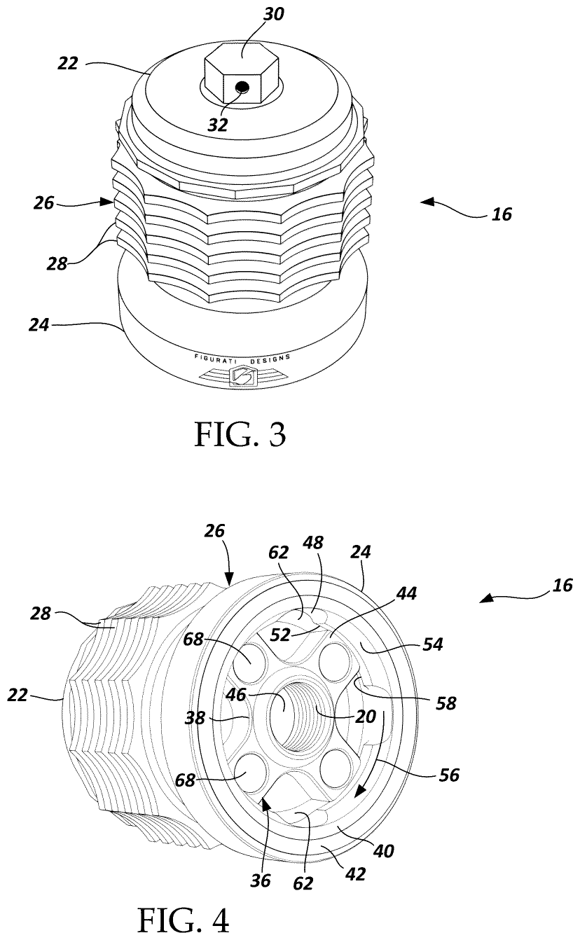

Perspective views of a distal end 22 and a proximate end 24 of oil filter 16 for filtering a portion of ferromagnetic material from engine oil circulating in internal combustion engine 12 are shown in FIG. 3 and FIG. 4, respectively. Oil filter 16 includes a housing 26 formed from a metal, metal alloy, or other material that is suitably durable for repeated use, and can withstand operating temperatures of internal combustion engine 12 and exposure to engine oil. For example, housing 26 can be formed from anodized aluminum, and optionally include one, or a plurality of ribs 28 that can serve an aesthetic purpose, and/or a functional purpose such adding surface area to promote heat dissipation or contributing to the structural rigidity of housing 26, for example.

Distal end 22 can optionally include a fastener head 30 that facilitates firm installation of oil filter 16 onto internal combustion engine 12, and removal of oil filter 16 from internal combustion engine 12. For example, fastener head 30 can include a hexagonal head or a head of another shape that can be gripped by a wrench, socket, or other tool. As another example, fastener head 30 can include an aperture 32 into which a tool can be at least partially inserted. Use of a tool forms a lever arm that gives a technician a mechanical advantage to exert a torque suitable to tighten oil filter 16 onto internal combustion engine 12 and prevent oil filter 16 from coming loose from internal combustion engine 12 during operation of motorcycle 10. Such a torque exerted by technician through use of the tool may exceed a maximum torque the technician is capable of exerting by hand, without a tool.

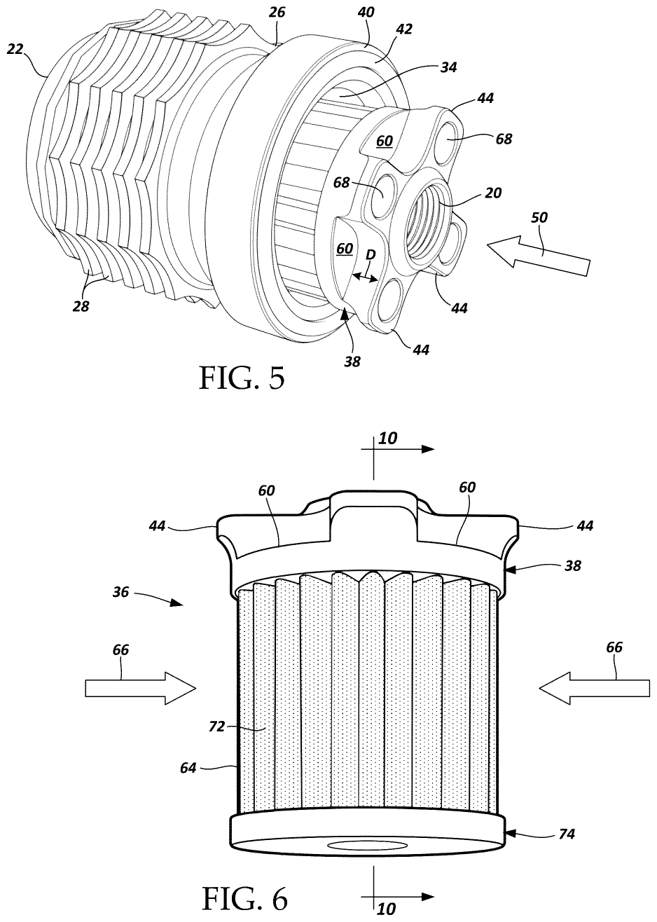

Proximate end 24 of oil filter 16 is an open end, through which oil from internal combustion engine 12 enters an interior space 34 (FIG. 5) defined at least in part by an interior periphery of housing 26. Interior space 34 can be generally cylindrical in shape, open at proximate end 24. Although the shape of interior space 34 can vary, interior space 34 contains oil entering oil filter 16 while in use. A filter element 36 of oil filter 16 is shown in FIG. 4 fully seated within interior space 34. In the fully seated position, an entry cap 38 of filter element 36 is at least partially recessed into interior space 34 from a plane of a perimeter surface 40 that defines an aperture leading into interior space 34.

With continued reference to FIG. 4 and FIG. 5, entry cap 38 of filter element 36 includes a plurality of leaves 44 (each individually referred to herein as a leaf 44). Each leaf 44 extends radially outward, generally away from a central aperture 46 that is encircled by internal threading 20. Internal threading 20 engages compatible threading provided to a conduit extending from internal combustion engine 12 to install oil filter 16 onto internal combustion engine 12. Each leaf 44 can extend radially outward to a greater extent R (FIG. 6) than other portions of entry cap 38, as shown in FIG. 5 and FIG. 6, to cooperate with a locking member 54 and seat filter within interior space 34.

To seat filter element 36 within interior space 34, filter element 36 is oriented so that each leaf 44 is aligned with a respective recess 48 (FIG. 4) adjacent to perimeter surface 40 of housing 26. Filter element 36 is inserted into interior space 34 generally in the direction indicated by arrow 50 (FIG. 5) until each leaf 44 is inserted beyond a camming surface 52 (FIG. 4) of a respective locking member 54 that protrudes in a radially-inward direction, into the aperture leading into interior space 34. Camming surface 52 can optionally be sloped, gradually extending along its length further into interior space 34. Once filter element 36 is fully inserted into interior space 34 so leaves 44 clear camming surfaces 52, filter element 36 is rotated relative to housing 26 in an angular direction generally indicated by arrow 56. Contact between leaves 44 and camming surface 52 gradually urge filter element 36 into interior space 34, toward distal end 22. According to some embodiments, relative rotation of filter element 36 can continue until a force exerted by camming surface 52 against at least one leaf 44 compresses filter element 36 against a far surface defining an innermost portion of interior space 34 to an extent that interferes with further relative rotation of filter element 36. In other words, according to such embodiments relative rotation of filter element 36 can continue until filter element 36 is suitably compressed between camming surface 52 and the surface defining innermost portion of interior space 34.

According to other embodiments, rotation of filter element 36 relative to housing 26 can continue until at least one leaf 44 contacts a rotation limiting surface 58 of locking member 54. According to such embodiments, rotation limiting surface 58 can include a protrusion or other object that extends inward, in a direction generally into interior space 34, that contacts a portion of a respective leaf 44 once filter element 36 is fully seated. Rotation limiting surface 58 can be positioned along camming surface 52 to make contact with a leaf 44 in response to rotation of housing 26 during installation of oil filter 16, interfering with angular adjustment of filter element 36 relative to housing 26. In other words, this contact between rotation limiting surface 58 and leaf 44 “locks” housing 26 to filter element 36. As a result, continued rotation of housing 26 urges filter element 36 to rotate in an angular direction that causes internal threading 20 defining central aperture 46 to engage external threading provided to conduit of internal combustion engine 21 in a manner that urges oil filter 16 toward internal combustion engine 12. Thus, oil filter 16 can be firmly installed on internal combustion engine 12.

Removal of filter element 36 can be accomplished by reversing the steps above to seat filter element 36 in interior space 34. For example, filter element 36 can be angularly adjusted in a direction opposite to the direction indicated by arrow 56. Once each leaf 44 is aligned with its respective recess 48, filter element 36 can be pulled from interior space 34 with leaves 44 passing through recesses 48.

A gasket 42 is provided to perimeter surface 40 to be compressed between perimeter surface 40 and an opposing surface of internal combustion engine 12. As internal threading 20 engages external threading of the conduit of internal combustion engine 12 during installation of oil filter 16, perimeter surface 40 is urged toward internal combustion engine 12, thereby compressing gasket 42 to an extent that forms an oil-tight seal between oil filter 16 and internal combustion engine 12.

Shown best in FIG. 5 and FIG. 7, entry cap 38 includes leaves 44 that protrude from webs 60 by a distance D. Webs 60 extend between adjacent leaves 44, and are aligned with respective recesses 48 while filter element 36 is fully seated within interior space 34 as shown in FIG. 5. A pathway collectively formed by distance D separating a surface of each web 60 from a surface of adjacent leaves 44 and its respective recess 48 forms an inlet port 62 through which oil flowing from internal combustion engine 12 enters interior space 34 of housing 26.

Although the embodiment of entry cap 38 shown in FIG. 5 and FIG. 7 is configured to form a portion of inlet port 62 through which oil enters housing 26 along with housing 26, the present disclosure is not so limited. According to alternate embodiments, for example, entry cap 38 can optionally be configured to fully define apertures as inlet ports 62 through which oil enters interior space 34 of housing 26. But regardless of the configuration of the inlet port 62, oil entering interior space 34 through inlet port 62 enters interior space 34 between an interior surface of housing 26 and an exterior surface of a perforated filter medium 64 (FIG. 6) of filter element 36.

At least one, a plurality, or all of leaves 44 can optionally be provided with a magnet 68. For example, magnet 68 can be a neodymium, rare-earth magnet having a magnetic field strength (magnetic flux density) of at least one thousand five hundred (1,500) gauss, at least two thousand (2,000) gauss, at least two thousand five hundred (2,500) gauss, or at least two thousand seven hundred (2,700) gauss. Magnet 68 can optionally be externally exposed so at least a portion of oil entering housing 26 of oil filter 16 makes contact with magnet 68 as it flows toward inlet port 62. According to alternate embodiments, magnet 68 can optionally be embedded within leaf 44, or otherwise concealed from direct exposure to oil entering housing 26. Regardless of whether magnet 68 makes direct contact with flowing oil, a magnetic field is generated by magnet 68 within the flow path of oil entering one or more of inlet ports 62 to magnetically attract ferromagnetic particles entrained within the oil, before the oil enters housing 26 through one or more inlet ports 62.

Although magnets 68 are shown in FIG. 4, FIG. 5 and FIG. 7 as being circular in shape, and coupled to externally-exposed surfaces of leaves 44, the present disclosure is not so limited. For example, alternate embodiments of oil filter 16 can include one or more magnets 68 having any shape. Further, magnet(s) 68 can be supported by any structure, such as one or more webs 60 for example, encountered by flowing oil before it passes through perforated filter medium 64.

Entry cap 38 defines central aperture 46, configured to form an outlet port through which filtered oil returns to internal combustion engine 12. As described in detail below, during normal operation oil enters oil filter 16 through inlet port 62 and passes through perforated filter medium 64 in a radially-inward direction, indicated generally by arrows 66 in FIG. 6 and FIG. 10, into a filtered oil chamber 70 (FIG. 7 and FIG. 10). At least a portion of particulate debris entrained in the oil is removed by the perforated filter medium 64. Filtered oil that has entered filtered oil chamber 70 through perforated filter medium is then returned to internal combustion engine 12 through central aperture 46 and threaded conduit of internal combustion engine 12 on which oil filter 16 is threadedly coupled by internal threading 20.

Perforated filter medium 64 can be a mesh formed from a metal, metal alloy, or other material with suitable temperature and oil resistance. For example, perforated filter medium 64 can include a corrugated, stainless-steel sheet formed into a generally-cylindrical shape, perforated with holes 72 (FIG. 6). An interior of the generally-cylindrical shape can form a periphery of filtered oil chamber 70 of filter element 16. Perforated filter medium 64 can have a linear length in an axial direction that is less than a linear distance separating entry cap 38 from bypass cap 74. Accordingly, a complete axial length of perforated filter medium 64 can be disposed between entry cap 38 and bypass cap 74. Opposite ends of perforated filter medium 64 can be welded, bonded or otherwise coupled to entry cap 38 and bypass cap 74 to couple the entry cap 38 and bypass gap 74 together, and interfere with the passage of oil between those opposite ends of perforated filter medium 64 and their respective entry cap 38 and bypass gap 74.

The holes 72 can have a greatest characteristic dimension that is selected to achieve a desired level of filtration. For example, holes 72 can optionally be round in shape, and have a diameter of 50 microns or smaller as their greatest characteristic dimension. According to alternate embodiments, holes 72 can optionally have a diameter of forty (40) microns or smaller as their greatest characteristic dimension, a diameter of thirty (30) microns or smaller as their greatest characteristic dimension, a diameter of twenty-five (25) microns or smaller as their greatest characteristic dimension, etc. Yet other embodiments can include holes 72 of any shape. For example, holes 72 can be formed as oval-shaped slits, or an aperture of any other shape formed in the stainless-steel sheet.

Perforated filter medium 64 extends in an axial direction between entry cap 38 and a bypass cap 74 as shown in FIG. 6 and FIGS. 8-11. With reference to FIG. 8, FIG. 9 and FIG. 10, bypass cap 74 defines an aperture 76 establishing fluid communication between oil within interior space 34 of housing 26 and a bypass valve assembly 78 coupled to bypass cap 74. According to the present embodiment, a peripheral surface of aperture 76 includes internal threading 80 that cooperates with complementary threading 82 provided to a portion of bypass valve assembly 78. For example, bypass valve assembly 78 can include an insert 84 to be installed within aperture 76 of bypass cap 74 to maintain other components of bypass valve assembly 78 within filter element 36. Insert 84 is provided with complementary threading 82 to allow for installation into, and subsequent removal from bypass cap 74, thereby granting access to internal components of bypass valve assembly 78 that are at least partially supported within filtered oil chamber 70 as described below.

Bypass cap 74 can include an inward-extending flange 92 (shown using hidden lines in FIG. 9) that limits an extent to which a portion of bypass valve assembly 78 can extend in an axial direction into filtered oil chamber 70. For example, bypass cap 74 can include a generally-cylindrical extension 94 that extends in an axial direction into filtered oil chamber 70. A distal end 96 of extension 94 can include flange 92, which extends in a radially-inward direction to interfere with further movement of a portion of bypass valve assembly 78 from aperture 76 into filtered oil chamber 70, in a direction generally toward entry cap 38.

Bypass valve assembly 78 includes a ball 86, a spring 88 and an internal magnet 90 configured to magnetically attract ferromagnetic material entrained in the oil. For example, internal magnet 90 can be a neodymium, rare-earth magnet having a magnetic field strength (magnetic flux density) of at least one thousand five hundred (1,500) gauss, at least two thousand (2,000) gauss, at least two thousand five hundred (2,500) gauss, or at least two thousand seven hundred (2,700) gauss.

Internal magnet 90 can optionally be substantially planar, having a generally-annular shape or otherwise define at least one aperture 98 through which oil can flow through internal magnet 90 into filtered oil chamber 70. Internal magnet 90 can include a diameter that is less than an internal diameter of extension 94, but greater than an internal diameter B (FIG. 9) of an aperture defined by flange 92. Accordingly, internal magnet 90 can rest against, or be supported by flange 92, thereby interfering with insertion of internal magnet 90 into filtered oil chamber 70 toward entry cap 38 beyond flange 92.

Oil having passed through perforated filter medium 64 into filtered oil chamber 70 can be exposed to a magnetic field generated by internal magnet 90, thereby further removing ferromagnetic debris that may have been too small to be effectively filtered from oil by perforated filter medium 64. For example, oil within filtered oil chamber 70 can pass through one or a plurality of apertures 102 (FIG. 10) defined by extension 94 to be exposed to a magnetic field of internal magnet 90. Oil entering extension 94 through one or more apertures 102 can flow through aperture 98 of internal magnet 90 to flow through central aperture 46 before returning to internal combustion engine 12 through the conduit. Further, oil within filtered oil chamber 70 may be exposed to a magnetic field of internal magnet 90 even without entering extension 94. For example, magnetic field generated by internal magnet 90 can also extend into a region of filtered oil chamber 70 between flange 92 and entry cap 38. Thus, oil entering oil filter 16 can be subjected to magnetic filtration by one or more magnets 68 before entering filtered oil chamber 70 by passing through perforated filter medium 64, and again within filtered oil chamber 70 by internal magnet 90.

Spring 88 can be inserted into extension 94 to exert a restorative force against flange 92 to bias ball 86 in a direction generally toward insert 84, causing ball 86 to be seated within an aperture 100 defined by insert 84 under normal operating conditions of oil filter 16. In other words, spring 88 can be at least partially inserted into extension 94, between internal magnet 90 and ball 86. Aperture 100 has a greatest characteristic dimension (e.g., internal diameter) that is less than a greatest characteristic dimension (e.g., external diameter) of ball 86, to prevent passage of ball 86 through aperture 100. Installation of insert 84 urges ball 86 generally toward internal magnet 90, compressing spring 88 between internal magnet 90 and ball 86, thereby seating ball 86 within aperture 100.

Spring 88 can be configured with a spring constant (k) to exert a spring force (F) when compressed a distance (x) from it's natural, unbiased length, in accordance with Hooke's Law given below as equation (i).

F=Kx Equation (i)

Spring force (F) establishes the desired threshold pressure above which bypass valve assembly 78 is operable to bypass filtration through perforated filter medium 64 return oil to internal combustion engine 12. In the event perforated filter medium 64 becomes fouled by excess particulate debris removed from oil, oil pressure within housing 26 may exceed a threshold pressure. In response to oil pressure exceeding that threshold pressure, the pressure of oil exerted generally in the direction of arrow 104 in FIG. 10 against ball 86 can exceed the spring force (F) exerted by spring 88 to seat ball 86 in aperture 100 of insert 84, causing ball 86 to become unseated from aperture 100. Unseated ball 86 further compresses spring 88 and forms a passage between ball 86 and portions of insert 84 defining aperture 100. Oil can flow through this passage around ball 86, through extension 94, through aperture 98 of internal magnet 90 and/or one or more apertures 102 of extension 94 into filtered oil chamber 70, before returning to internal combustion engine 12 through central aperture 46. Accordingly, even if perforated filter medium 64 becomes fouled to an extent that could otherwise impede the flow of oil through oil filter 16, operation of bypass valve assembly 78 can avoid starving internal combustion engine 12 of oil.

Oil filter 16 can be serviced by users and reused even after perforated filter medium 64 has become fouled. Filter element 36 can be angularly adjusted relative to housing 26 within interior space 34 to align leaves 44 with respective recesses 48 (FIG. 4), and then pulled from interior space 34. A tool can engaged a hex socket 110 (FIG. 8 and FIG. 9) or other feature to angularly adjust insert 84 relative to bypass cap 74 until complementary threading 82 of insert 84 disengages internal threading 80 of bypass cap 74, and insert 84 is removed from bypass cap 74. Once insert 84 is removed, ball 86, spring 88 and internal magnet 90 can also be removed from bypass cap 74, exposing surfaces on which filtered debris can be rinsed or otherwise removed from portions of bypass cap 74, perforated filter medium 64, and/or other portions of filter element 36. Components of bypass valve assembly 78 can then be assembled within extension 94 of bypass cap 74, and insert 84 rethreaded into aperture 76.

FIG. 11 is an exploded view of an alternate embodiment of a filter element 36 in accordance with the present disclosure. Bypass cap 74 of the present embodiment again defines an aperture 106, similar to aperture 76 of the preceding embodiment. But instead of having internal threading 80 that removably engages an insert 84, ball 86 of the present embodiment is seated directly in aperture 106 of bypass cap 76 rather than within aperture 100 of insert 84 as in the above embodiment. Extension 94 again extends into filtered oil chamber 70, and includes flange 92 to support magnet 90 and interfere with insertion of magnet 90 into filtered oil chamber 70 beyond flange. But the present embodiment of bypass cap 74 includes a male extension 108 that is concentrically received by extension 94 to contain the components of bypass valve assembly 78. Despite the different construction, bypass valve assembly 78 operates to avoid starving internal combustion engine 12 of oil as described above.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An oil filter for filtering ferromagnetic material from engine oil, the oil filter comprising:
a housing having an interior space; and
a filter element at least partially received within the interior space, the filter element having:
an entry cap that forms (i) at least a portion of an inlet port configured to allow engine oil to enter the housing, and (ii) at least a portion of an outlet port configured to allow engine oil to exit the housing;
a bypass cap;
a perforated-filter medium having a linear length that is less than a linear distance from the entry cap to the bypass cap,
the perforated-filter medium forming a periphery of a filtered-oil chamber;
a magnet, wherein at least a portion of the magnet is positioned within the filtered-oil chamber and configured to magnetically attract ferromagnetic material; and
a bypass-valve assembly coupled to the bypass cap, wherein the bypass-valve assembly is operable in response to an oil pressure within the housing exceeding a threshold pressure to cause a portion of oil within the housing to bypass the perforated-filter medium.

2. The oil filter for filtering ferromagnetic material from engine oil of claim 1, wherein the magnet forms a portion of the bypass-valve assembly, and wherein the bypass-valve assembly further comprises:
a ball configured to be at least partially received within a bypass-cap aperture; and
a spring disposed between the ball and the magnet, wherein the spring is configured to impart a directional force on the ball.

3. The oil filter for filtering ferromagnetic material from engine oil of claim 2, wherein the spring is further configured to: (i) seat the ball in the bypass-cap aperture when oil pressure in the housing is less than the threshold pressure, and (ii) allow the ball to become at least partially unseated in response to oil pressure in the housing exceeding the threshold pressure.

4. The oil filter for filtering ferromagnetic material from engine oil of claim 2, wherein the magnet has:
a substantially planar surface; and
a magnet aperture configured to allow oil to flow therethrough.

5. The oil filter for filtering ferromagnetic material from engine oil of claim 2, wherein the bypass cap comprises a flange that interferes with movement of the magnet within the filtered oil chamber, in a direction generally toward the entry cap.

6. The oil filter for filtering ferromagnetic material from engine oil of claim 5, wherein the magnet has an annular shape.

7. The oil filter for filtering ferromagnetic material from engine oil of claim 2 further comprising an insert that is configured to be inserted into the bypass-cap aperture, wherein the insert is configured to be removable from the bypass-cap aperture and thereby grant access to the magnet within the filtered-oil chamber.

8. The oil filter for filtering ferromagnetic material from engine oil of claim 7, wherein the bypass cap comprises bypass-cap threading and the insert comprises complementary threading that is compatible with the bypass-cap threading.

9. The oil filter for filtering ferromagnetic material from engine oil of claim 7, wherein the ball, the spring, and the magnet are removable from the filter element via the bypass-cap aperture while the insert is removed.

10. An oil filter for filtering ferromagnetic material from engine oil, the oil filter comprising:
a housing having an interior space; and
a filter element at least partially within the interior space, the filter element having:
an entry cap that forms (i) at least a portion of an inlet port configured to allow engine oil to enter the housing, and (ii) at least a portion of an outlet port configured to allow engine oil to exit the housing;
a bypass cap having a bypass-cap aperture and a removable insert within the bypass-cap aperture;
a perforated-filter medium having a linear length that is less than a linear distance from the entry cap to the bypass cap, the perforated-filter medium forming a periphery of a filtered-oil chamber;
a magnet, wherein at least a portion of the magnet is positioned within the filtered-oil chamber and configured to magnetically attract ferromagnetic material; and
a bypass-valve assembly that is configured to cause a portion of oil within the housing to bypass the perforated filter medium in response to an oil pressure within the housing exceeding a threshold pressure, wherein
upon removing the removable insert, the magnet may be removed from the filter element via the bypass-cap aperture.

11. The oil filter for filtering ferromagnetic material from engine oil of claim 10, wherein the bypass cap comprises threading and the removable insert comprises complementary threading that is compatible with the threading of the bypass cap.

12. The oil filter for filtering ferromagnetic material from engine oil of claim 10, wherein the magnet forms a portion of the bypass-valve assembly, and wherein the bypass-valve assembly further comprises:
a ball configured to be at least partially received within an insert aperture; and
a spring disposed between the ball and the magnet, wherein the spring is configured to impart a directional force on the ball.

13. The oil filter for filtering ferromagnetic material from engine oil of claim 12, wherein the spring is further configured to: (i) seat the ball in the bypass-cap aperture the oil pressure in the housing is less than the threshold pressure, and (ii) allow the ball to become at least partially unseated in response to oil pressure in the housing exceeding the threshold pressure.

14. The oil filter for filtering ferromagnetic material from engine oil of claim 12, wherein the ball and the spring are removable from the filter element via the bypass-cap aperture while the insert is removed.

15. The oil filter for filtering ferromagnetic material from engine oil of claim 10, wherein the magnet has:
a substantially planar surface, and
a magnet aperture configured to allow oil to flow therethrough.

16. The oil filter for filtering ferromagnetic material from engine oil of claim 10, wherein the bypass cap comprises a flange that interferes with movement of the magnet within the filtered oil chamber, in a direction generally toward the entry cap.

17. The oil filter for filtering ferromagnetic material from engine oil of claim 10, wherein the entry cap comprises a second magnet supported externally of the filtered oil chamber, wherein the position of the second magnet is configured to be within a flow path of oil into the housing.

18. The oil filter for filtering ferromagnetic material from engine oil of claim 17, wherein the entry cap comprises a second and third magnet supported externally of the filtered oil chamber, wherein the position of the second and third magnet is configured to be within the flow path of oil into the housing.

19. The oil filter for filtering ferromagnetic material from engine oil of claim 17, wherein the entry cap comprises a second, third, and fourth magnet supported externally of the filtered oil chamber, wherein the position of the second, third, and fourth magnet is configured to be within the flow path of oil into the housing.
